(19) United States
(12) Patent Application Publication
(10) Pub. No.: US 2024/0296741 A1
(43) Pub. Date: Sep. 5, 2024

(54) PARKING MANAGEMENT SYSTEM

(71) Applicant: TOYOTA JIDOSHA KABUSHIKI KAISHA, Aichi-ken (JP)

(72) Inventors: Naoki HASEGAWA, Aichi-ken (JP); Takuji MATSUBARA, Aichi-ken (JP); Osamu YUMITA, Aichi-ken (JP); Sa KANO, Aichi-ken (JP)

(21) Appl. No.: 18/581,395

(22) Filed: Feb. 20, 2024

(30) Foreign Application Priority Data
Mar. 1, 2023 (JP) 2023-031405

(51) Int. Cl. G08G 1/14; B60L 53/00; B60L 55/00

(52) U.S. Cl. CPC G08G 1/148; B60L 53/00; B60L 55/00

(57) ABSTRACT

A parking management system comprises a first information management section that manages first parking information related to parking in the first parking space and first vehicle information related to vehicles parked in the first parking space; a second information management section that manages second parking information related to parking in the second parking space and second vehicle information related to vehicles parked in the second parking space; a condition determination section that determines the existence of a space condition in which a parkable space exists in the second parking space based on the second parking information of the second information management section, and determines the existence of a movable condition where a movable vehicle exists in the second parking space based on the first vehicle information of the first parking management section.

### CROSS-REFERENCE TO RELATED APPLICATION

The present disclosure claims priority to Japanese Patent Application No. 2023-031405 filed on Mar. 1, 2023, which is incorporated herein by reference in its entirety including specification, drawings and claims.

### TECHNICAL FIELD

The present disclosure relates to the parking management system, and more particularly to the parking management system for the predetermined facility having a plurality of parking spaces, including the first parking space and the second parking space.

### BACKGROUND

In a system with a storage battery installed in a parking lot, an AC power converter for this storage battery, and a charging and discharging stand for electric vehicles, it has been proposed that the charging and discharging stand or the AC power converter can also supply power to the load (see, for example, Patent Document 1). In this system, power is supplied to the load from a charging and discharging stand or an AC power converter. This allows power to be supplied to the load even when there is an abnormality in the commercial power system.

### CITATION LIST

### Patent Literature

PTL 1: JP2020-010442

### SUMMARY

The parking lot, where the battery mounted on the vehicle is chargeable and dischargeable, must be linked to the power demand at the facility that exchanges power with the parking lot. The parking lot is expected to have multiple parking42paces, including the chargeable parking space where the battery mounted on the parked vehicle can be charged and the discharge parking space where the battery mounted on the parked vehicle can be discharged. In such parking lots, if vehicles are parked in the same parking space for an extended period of time, the parking lot will not be able to coordinate well with the electricity demand of the facility that exchanges electricity with the parking lot.

The main purpose of the parking management system of the present disclosure is to better coordinate the parking lot with the electricity demand of the facility that exchanges electricity with the parking lot.

The parking management system of the present disclosure has adopted the following measures to achieve the main objectives described above.

The parking management system of this disclosure for a predetermined facility with multiple parking spaces, including a first parking space and a second parking space; wherein the parking management system comprising
a first information management section that manages first parking information related to parking in the first parking space and first vehicle information related to vehicles parked in the first parking space;
a second information management section that manages second parking information related to parking in the second parking space and second vehicle information related to vehicles parked in the second parking space;
a condition determination section that determines the existence of a space condition in which a parkable space exists in the second parking space based on the second parking information of the second information management section, and determines the existence of a movable condition where a movable vehicle exists in the second parking space based on the first vehicle information of the first parking management section.

In the parking management system of the present disclosure, the first information management section manages the first parking information related to parking in the first parking space and the first vehicle information related to the vehicle parked in the first parking space, and the second information management section manages the second parking information related to parking in the second parking space and the second vehicle information related to the vehicle parked in the second parking space. The condition determination section determines the existence of a space condition in which a parkable space exists in the second parking space based on the second parking information of the second information management section, and section determines the existence of a movable condition where a movable vehicle exists in the second parking space based on the first vehicle information of the first parking management section. By moving the vehicle for which the movable condition is satisfied to the second parking space when the space condition is satisfied, the parking lot can be better coordinated with the power demand of the facility that exchanges power with the parking lot.

### BRIEF DESCRIPTION OF DRAWINGS

FIG. 1 shows a schematic of the configuration of the parking management system 10 including the integrated parking management device 20 as one embodiment of this disclosure.

FIG. 2 shows a schematic configuration of the electric vehicle 120 that moves through each parking space.

FIG. 3 shows a flowchart of an example of the first movement management process executed by the integrated parking management device 20.

FIG. 4 shows a flowchart of an example of the second movement management process executed by the integrated parking management device 20.

FIG. 5 shows a flowchart of an example of the third movement management process executed by the integrated parking management device 20.

### DESCRIPTION OF EMBODIMENTS

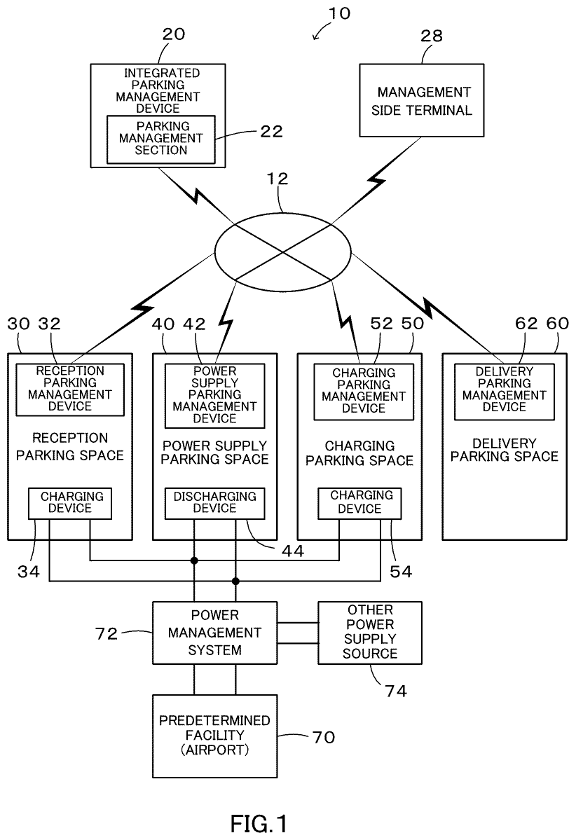

Next, the embodiment of this disclosure will be described. FIG. 1 shows a schematic of the configuration of the parking management system 10 including the integrated parking management device 20 as one embodiment of this disclosure. The parking management system 10 is equipped with the communication network 12 (wired or wireless), the integrated parking management device 20 connected to the communication network 12, each management device 32, 42, 52, 62 connected to the communication network 12 and located in each parking space 30, 40, 50, 60, and the management side terminal 28 connected to the communication network 12.

The integrated parking management device 20 is a device that manages parking in each parking space (the reception parking space 30, the power supply parking space 40, the charging parking space 50, the delivery parking space 60) ached to a predetermined facility 70 (for example, an airport, etc.), and is composed of a microcomputer, for example. The integrated parking management device 20 is equipped with a communication device (not shown) for communicating with the communication network 12 and the parking management section 22 that manages parking in each of the parking spaces 30, 40, 50, and 60. The parking management section 22 is a functional block that functions as a combination of hardware and application software.

The management side terminal 28 is a portable terminal carried by the attendant who manages each parking space 30, 40, 50, 60 or a terminal at the waiting area where the attendant waits, and is composed of a microcomputer, for example.

The reception parking space 30 is a parking space for accepting parking and, if necessary, charging the battery mounted on the vehicle, and has the reception parking management device 32 and the charging device 34. The reception parking management device 32 inputs and stores the reception space usage information indicating the use of the reception parking space 30 and the reception vehicle information indicating the vehicles parked in the reception parking space 30, and it transmits the reception space usage information and necessary reception vehicle information to other management devices via the communication network 12 upon request. The reception space usage information includes the usage status (available space) of the multiple individual spaces (parking slots) that the reception parking space 30 has. The reception vehicle information includes the scheduled entry date and time to the parking lot, the scheduled exit date and time, and the storage ratio SOC of the battery at the time of exit (the exit battery storage ratio), which are entered by the user using a parking use form or other means, the permission to use the power supply to the predetermined facility 70, the type of vehicle, the total capacity of the battery mounted on the vehicle, and the storage ratio SOC of the battery, which are input through communication with the controller on the vehicle side. The storage ratio SOC is the ratio of the remaining capacity to the total capacity of the battery. The exit battery storage ratio corresponds to 100% when the user enters a full charge and corresponds to the ratio of the sum of the entered amount of electric energy and the remaining capacity to the total capacity of the battery when the user enters the amount of electric energy to be charged. When the user enters the charge by amount, the exit battery storage ratio corresponds to the ratio of the sum of the electric energy that divided by monetary value entered per unit of electric energy and the remaining capacity to the total capacity of the battery. If the exit battery storage ratio is not entered, the storage ratio SOC of the battery at the time of entry is assigned as the exit battery storage ratio. The charging device 34 is connected to the other power supply source 74 via the power management system 72 by a power line and charges the battery mounted on the vehicle parked in the reception parking space 30 using power from the other power supply source 74. The storage ratio SOC of the battery included in the reception vehicle information is updated sequentially during charging by the charging device 34.

The power supply parking space 40 is a parking space for supplying power from batteries mounted on the vehicles moved and parked from the reception parking space 30 to the predetermined facility 70 as needed, and includes the power supply parking management device 42 and the discharging device 44. The power supply parking management device 42 inputs and stores the power supply space usage information indicating the usage of the power supply parking space 40 and the power supply vehicle information indicating the vehicles parked in the power supply parking space 40, and it transmits the power supply space usage information and, if necessary, the power supply vehicle information to other management devices via the communication network 12 upon request. The power supply vehicle information is the reception vehicle information obtained from the reception parking device management 32 through communication immediately after the vehicle is moved from the reception parking space 30 to the power supply parking space 40, and is updated as necessary thereafter. The discharging device 44 is connected to the predetermined facility 70 via the power management system 72 by a power line and supplies power from the battery mounted on the vehicle parked in the power supply parking space 40 to the predetermined facility 70 as needed. In other words, vehicles parked in the power supply parking space 40 function as a virtual power plant (VPP: Virtual Power Plant). The storage ratio SOC of the battery included in the power supply vehicle information is updated sequentially during discharging by the discharging device 44.

The charging parking space 50 is a parking space for charging the battery mounted on the vehicle that is moved from the power supply parking space 40 to the parking space, and equipped with the charging parking management device 52 and the charging device 54. The charging parking management device 52 inputs and stores the charging space usage information indicating the usage of the charging parking space 50 and the charging vehicle information indicating the vehicles parked in the charging parking space 50, and it transmits the charging space utilization information and, if necessary, the charging vehicle information to other management devices via the communication network 12 upon request. The charging vehicle information is the power supply vehicle information obtained from the power supply parking management device 42 through communication immediately after the vehicle is moved from the power supply parking space 40 to the charging parking space 50, and is updated as necessary thereafter. The charging device 54 is connected to the other power supply source 74 via the power management system 72 by a power line and charges the battery mounted on the vehicle parked in the charging parking space 50 using power from the other power supply source 74. Charging by the charging device 54 in the charging parking space 50 is to charge the vehicle until it reaches the exit battery storage ratio entered by the user in the vehicle information. The storage ratio SOC of the battery included in the vehicle information is updated sequentially during charging by the charging device 54.

The delivery parking space 60 is a parking space for vehicles to be moved from the reception parking space 30 or charging parking space 50 and delivered to users, and has the delivery parking management device 62. The delivery parking management device 62 inputs and stores the delivery space usage information indicating the usage of the delivery parking space 60 and the delivery vehicle information indicating the vehicles parked in the delivery parking space 60. The delivery parking management device 62 transmits the delivery space usage information and necessary delivery vehicle information to other management devices via the communication network 12 upon request. The delivered vehicle information is the charging vehicle information obtained from the charging parking management device 52 through communication immediately after the vehicle is moved from the charging parking space 50 to the delivery parking space 60, and is then updated as necessary.

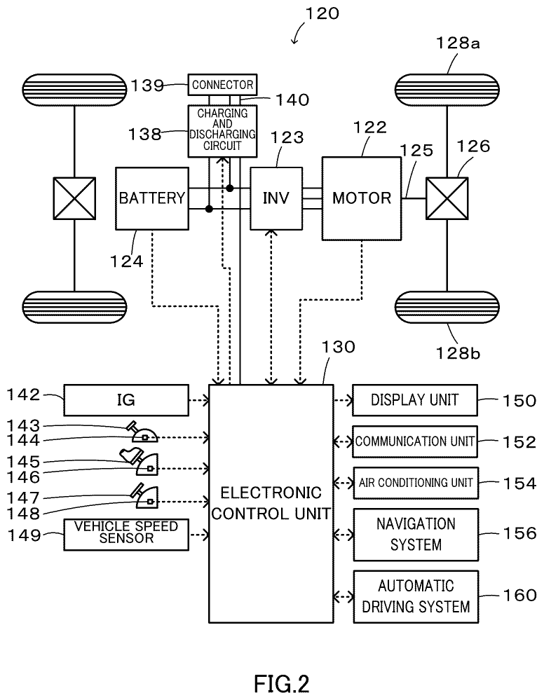

The vehicle that moves each parking space in the embodiment can be, for example, the electric vehicle 120 illustrated in FIG. 2. The electric vehicle 120 is equipped with the motor 122, the inverter 123, the battery 124, the charging and discharging circuit 138, the connector 139, and the electronic control unit 130, and the automatic driving system 160.

The motor 122 is configured, for example, as the synchronous generator motor. The rotor of the motor 122 is connected to the drive shaft 125 connected to the drive wheels 128a, 128b via the differential gear 126. The motor 122 is driven by three-phase AC power applied by the inverter 123 after DC power from the battery 124 is converted to three-phase AC power by the inverter 123. The battery 124 is configured as a well-known lithium-ion rechargeable battery or nickel-metal hydride rechargeable battery.

The charging and discharging circuit 138 is connected at one end to a power line connected to the battery 124 and at the other end to the connector 139 for connection to the charging device 34,54 or the discharging device 44. The charging and discharging circuit 138 has the charging and discharging relay, which is not shown in the figure. The charging and discharging circuit 138 is connected to and disconnected from the battery 124 by the charging and discharging relay.

The electronic control unit 130 is configured as a microcomputer, which is mainly composed of a CPU, not shown in the figure. The electronic control unit 130 receives signals from various sensors via input ports. For example, the electronic control unit 130 inputs the ignition signal from the ignition switch 142, the shift position SP from the shift position sensor 144 that detects the position of the shift lever 143, the acceleration Acc from the accelerator pedal position sensor 146 that detects the amount of depressing the accelerator pedal 145, the brake position BP from the brake pedal position sensor 148 that detects the amount of depressing the brake pedal 147, and the vehicle speed V from the speed sensor 149. The electronic control unit 130 also inputs the rotation position θ from the rotation position sensor (not shown) that detects the rotation position of the motor 122, the battery voltage Vb from the voltage sensor (not shown) attached to the output terminal of the battery 124, the battery current Ib from the current sensor (not shown) attached to the output terminal of the battery 124, the charging and discharging voltage Vchg from the voltage sensor attached to the charging and discharging circuit 138, and the charging and discharging current Ichg from the current sensor attached to the charging and discharging circuit 138.

The electronic control unit 130 outputs various control signals via output ports. For example, the electronic control unit 130 outputs the display control signals to the display unit 150, the communication control signals to the communication unit 152, and the air conditioning control signals to the air conditioning unit 154. The electronic control unit 130 also outputs the switching control signals for switching the switching elements (not shown) to the inverter 123 to drive the motor 122, the drive control signals to the system main relay (not shown) mounted near the battery 124, and the drive control signal to the charging and discharging relay (not shown) attached to the charging and discharging circuit 138. The electronic control unit 130 has the signal line 140 connected to it to communicate with the charging device 34,54 or discharging device 44 when the charging device 34,54 or discharging device 44 is connected via the connector 139. The electronic control unit 130 communicates with the navigation system 156, which displays various information and provides route guidance. The electronic control unit 130 communicates with the automatic driving system 160 that drives the vehicle automatically.

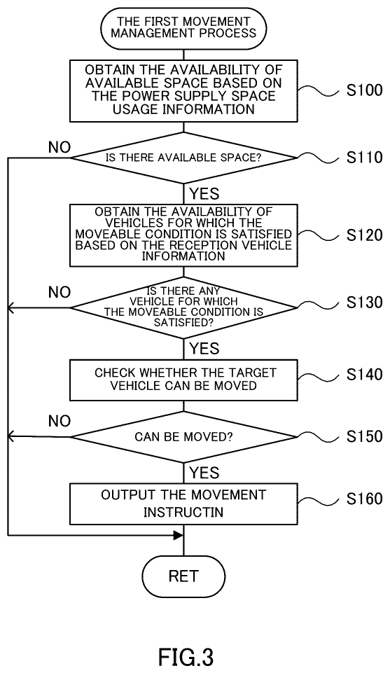

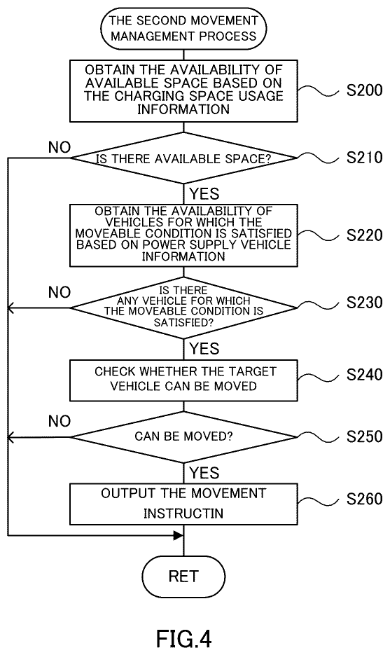

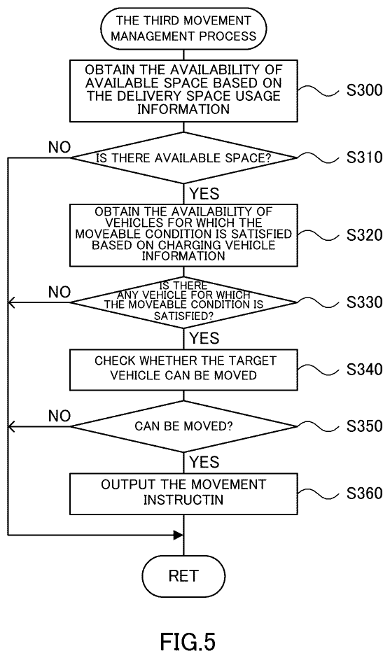

Next, the operation of the integrated parking management device 20 of the embodiment, especially the operation of the integrated parking management device 20 (the parking management section 22) when moving vehicles from the reception parking space 30 to the power supply parking space 40, will be described, moving vehicles from the power supply parking space 40 to the charging parking space 50, and moving vehicles from the charging parking space 50 to the delivery parking space 60. FIG. 3 is a flowchart showing an example of the first movement management process executed by the integrated parking management device 20 when moving a vehicle from the reception parking space 30 to the power supply parking space 40. FIG. 4 is a flowchart showing an example of the second movement management process executed by the integrated parking management device 20 when moving a vehicle from the power supply parking space 40 to the charging parking space 50. FIG. 5 is a flowchart showing an example of the second movement management process executed by the integrated parking management device 20 when moving a vehicle from the charging parking space 50 to the delivery parking space 60. The first movement management process, the second movement management process, and the third movement management process are executed repeatedly at predetermined time intervals. The following is a sequential explanation.

When the first movement management process is executed, the integrated parking management device 20 first obtains the availability of available space in the power supply parking space 40 based on the power supply space usage information (step S100). This process can be performed by obtaining the power supply space usage information from the power supply parking management device 42 in the power supply parking space 40 and extracting available spaces from the power supply space usage information. Alternatively, this process can be performed by extracting available spaces based on the power supply parking management device 42 based on the power supply space usage information and obtaining the results from the power supply parking management device 42. The integrated parking management device 20 then determines whether or not there are available spaces in the power supply parking space 40 (step S110). When the integrated parking management device 20 determines that there are no available spaces, it determines that the vehicle cannot be moved from the reception parking space 30 to the power supply parking space 40 and ends the first movement management process.

When the integrated parking management device 20 determines that there is available space in the power supply parking space 40 in step S110, it obtains the availability of vehicles for which the moveable condition is satisfied based on the reception vehicle information (step S120). This process can be performed by obtaining the reception vehicle information from the reception parking management device 32 in the reception parking space 30 and extracting vehicles that meet the conditions for being able to move. Alternatively, this process can be performed by extracting the vehicles that meet the mobility conditions based on the reception vehicle information by the reception parking management device 32 and receiving the results from the reception parking management device 32. The moveable condition can be a condition in which the user is permitted to use the power supply to the predetermined facility 70 and the storage ratio SOC of the onboard battery is at or above the first predetermined storage ratio (e.g., 90% or 95%), which is close to full charge (100%). The integrated parking management device 20 then determines whether there are vehicles for which the moveable condition is satisfied (step S130). When the integrated parking management device 20 determines that there are no vehicles for which the moveable condition is satisfied, it determines that the vehicle cannot be moved from the reception parking space 30 to the power supply parking space 40 and ends the first move management process.

When the integrated parking management device 20 determines that a vehicle has a moveable condition in step S130, it checks whether the target vehicle can be moved (step S140) and determines whether the target vehicle can be moved (step S150). Confirmation of whether or not the target vehicle can be moved can be made based on the reception vehicle information and whether or not the user is authorized to supply power. When the integrated parking management device 20 determines that the move cannot be made through the confirmation process, it ends the first move management process.

When the integrated parking management device 20 determines that the vehicle is moveable in step S150, it outputs the movement instruction to move the target vehicle from the reception parking space 30 to an available space in the power supply parking space 40 (step S160) and ends the first movement management process. The movement instruction, if the subject vehicle is a vehicle that can be driven automatically, can be performed by outputting to the subject vehicle the information for moving to an available space in the power supply parking space 40 by automatic operation and the location information of the available space in the power supply parking space 40. The movement instruction, if the subject vehicle is a vehicle that cannot be driven automatically, can be performed by outputting to the management side terminal 28 the location information indicating the parking position of the subject vehicle in the reception parking space 30 and the location information of the available space in the power supply parking space 40. If the subject vehicle is a vehicle that can be driven automatically, the subject vehicle will move to an available space in the power supply parking space 40 by automatic operation based on the movement instruction. If the subject vehicle is a vehicle that cannot be driven automatically, the attendant moves the subject vehicle to an available space in the power supply parking space 40 based on the movement instruction output to the management side terminal 28. In this case, the locking ID may be given.

The first movement control process described above allows vehicles parked in the reception parking space 30 whose storage ratio SOC of the battery installed in the vehicle is greater than the first predetermined storage ratio to be moved to the power supply parking space 40. As a result, this allows for available space in the reception parking space 30 and better charging of the battery mounted on the vehicle in the reception parking space 30. It also allows vehicles to be moved quickly to available spaces in the power supply parking space 40. As a result, the power supply from the battery on the vehicle to the predetermined facility in the power supply parking space 40 can be better. In other words, by making a decision that takes into account the storage ratio SOC of the battery, deterioration due to overcharging of the battery of the vehicle can be suppressed, and the battery can be charged more favorably. In addition, available space may be left in power supply parking space 40 during normal times, and vehicles parked in the reception parking space 30 may be moved to the power supply parking space 40 when there is a need to supply power to the predetermined facility 70. In this way, the situation where the power supply parking space 40 is filled by vehicles that cannot supply power to the predetermined facility 70 when it needs to be supplied can be eliminated, as well as efficient power management can be performed. In addition, the power supply parking space 40 may be located at a closer distance from the predetermined facility 70. In this way, the length of the transmission line from the discharging device 44 to the predetermined facility 70 can be shortened, thus reducing power transmission losses and making for a better supply of power. In the first movement management process, the reception parking space 30 corresponds to the “first parking space” and the power supply parking space 40 corresponds to the “second parking space”.

When the second movement management process in FIG. 4 is executed, the integrated parking management device 20 first obtains the availability of available space in the charging parking space 50 based on the charging space usage information (step S200). This process can be performed by obtaining the charging space usage information from the charging parking management device 52 of the charging parking space 50 and extracting available spaces from the charging space usage information. Alternatively, this process can be performed by extracting available spaces based on the charging space usage information by the charging parking management device 52 and obtaining the results from the charging parking management 52. The integrated parking management device 20 then determines whether or not there are available spaces in the charging parking space 50 (step S210). When the integrated parking management device 20 determines that there are no available spaces, it decides that the vehicle cannot be moved from the power supply parking space 40 to the charging parking space 50 and ends the second movement management process.

When the integrated parking management device 20 determines that there is available space in the charging parking space 50 in step S210, it obtains the availability of vehicles for which the moveable condition is satisfied based on the power supply vehicle information (step S220). This process can be performed by obtaining power supply vehicle information from the power supply parking management device 42 in the power supply parking space 40 and extracting vehicles for which the moveable condition is satisfied. Alternatively, this process can be performed by extracting vehicles for which the moveable condition is satisfied based on the power supply vehicle information by the power supply parking management device 42 and receiving the result from the power supply parking management device 42. The movable condition can be a condition that allows the battery to be charged to the exit battery storage ratio by the scheduled exit date and time with sufficient time to spare, or a condition in which the storage ratio SOC of the on-board battery is less than the second predetermined storage ratio (e.g., 20%, 30%, 40%, etc.), which is a relatively small ratio. The integrated parking management device 20 determines whether there is a vehicle for which the movable condition is satisfied (step S230). When the integrated parking management device 20 determines that there is no vehicle for which the moveable condition is satisfied, it determines that the vehicle cannot be moved from the power supply parking space 40 to the charging parking space 50, and ends the second movement management process.

When the integrated parking management device 20 determines that there is a vehicle for which the moveable condition is satisfied in step S230, it confirms whether or not the target vehicle can be moved (step S240) and determines whether or not the target vehicle can be moved (step S250). When the integrated parking management device 20 determines that the vehicle cannot be moved by the confirmation process, it ends the second movement management process. On the other hand, when the integrated parking management device 20 determines that the vehicle is moveable, instruction to move the target it outputs the movement vehicle from the power supply parking space 40 to an available space in the charging parking space 50 (step S260), and ends the second movement management process. The movement instruction, if the subject vehicle is a vehicle that can be driven automatically, is made by outputting to the subject vehicle the information for moving to an available space in the charging parking space 50 by automatic operation and the location information of the available space in the charging parking space 50. Alternatively, the movement instruction, if the subject vehicle is a vehicle that cannot be driven automatically, is made by outputting to the management side terminal 28 the location information indicating the parking position of the subject vehicle in the power supply parking space 40 and the location information of the available space in the charging parking space 50. The movement of the subject vehicle is similar to the movement from the reception parking space 30 to the power supply parking space 40.

The second movement control process described above allows vehicles parked in the power supply parking space 40 whose storage ratio SOC of the battery mounted on the vehicle is less than the second predetermined storage ratio to be moved to the charging parking space 50. As a result, this allows for available space in the power supply parking space 40 and better power supply to the predetermined facility 70 from the battery mounted on the vehicle in the power supply parking space 40. It also allows vehicles to be moved quickly to available spaces in the charging parking space 50. This results in better charging of the battery mounted on the vehicle in the charging parking space 50. That is, by making a judgment that takes into account the storage ratio SOC of the battery, deterioration due to over-discharge of the battery of the vehicle can be suppressed, and better charging/discharging can be performed. In addition, available space may be left in charging parking space 50 during normal times, the vehicles parked in the power supply parking space 40 whose storage ratio SOC of the battery has dropped may be immediately moved to the charging parking space 50, and the vehicles parked in the reception parking space 30 may be moved to the power supply parking space 40 at the timing when the available power supply parking space 40 is required to supply power to the predetermined facility 70. In this way, the situation where the power supply parking space 40 is filled by vehicles that cannot supply power at the timing when power r needs to be supplied to the predetermined facility 70 can be eliminated, as well as efficient power management can be performed. In the second movement management process, the power supply parking space 40 corresponds to the “first parking space” and the charging parking space 50 corresponds to the “second parking space”.

When the third movement management process in FIG. 5 is executed, the integrated parking management device 20 first obtains whether there are available spaces in the delivery parking space 60 based on the delivery space usage information (step S300). This process can be performed by obtaining the delivery space usage information from the delivery parking management device 62 in the delivery parking space 60 and extracting available spaces from the delivery space usage information. Alternatively, this process can be performed by extracting available spaces based on the delivery space usage information by the delivery parking management device 62 and obtaining the results from the delivery parking management device 62. The integrated parking management device 20 then determines whether there is available space in the delivery parking space 60 (step S310). When the integrated parking management device 20 determines that there is no available space in the delivery parking space 60, it determines that the vehicle cannot be moved from the charging parking space 50 to the delivery parking space 60, and ends the third movement management process.

When the integrated parking management device 20 determines that there is available space in the delivery parking space 60 in step S310, it obtains the availability of vehicles for which the moveable condition is satisfied based on the charging vehicle information (step S320). This process can be performed by obtaining the charging vehicle information from the charging parking management device 52 in the charging parking space 50 and extracting the vehicles for which the moveable condition is satisfied. Alternatively, this process can be performed by using the charging parking management device 52 to extract vehicles for which the moveable condition is satisfied based on the charging device information, and receiving the result from the charging parking management device 52. The moveable condition can be a condition where the scheduled exit date and time is near and the storage ratio SOC of the battery is at the exit battery storage ratio. The integrated parking management device 20 then determines whether or not there is a vehicle for which the moveable condition is satisfied (step S330). When the integrated parking management device 20 determines that there are no vehicles for which the moveable condition is satisfied, it determines that the vehicle cannot be moved from the charging parking space 50 to the delivery parking space 60, and ends the third move management process.

When the integrated parking management device 20 determines that there is a vehicle for which the moveable condition is satisfied in step S330, it confirms whether or not the target vehicle can be moved (step S340) and determines whether or not the target vehicle can be moved (step S350). When the integrated parking management device 20 determines that the move cannot be made through the confirmation process, it ends the third move management process. On the other hand, when the integrated parking management device 20 determines that the vehicle can be moved, it outputs the movement instruction to move the subject vehicle from the charging parking space 50 to an available space in the delivery parking space 60 (step S360) and ends the third movement management process. The movement instruction, if the subject vehicle is a vehicle that can be driven automatically, is output to the subject vehicle with information for moving to an available space in the delivery parking space 60 by automatic operation and the location information of an available space in the delivery parking space 60. The movement instruction, if the subject vehicle is a vehicle that cannot be driven automatically, is output to the management side terminal 28 with the location information indicating the parking position of the subject vehicle in the charging parking space 50 and the location information of the available space in the delivery parking space 60. The movement of the subject vehicle is the same as moving from the reception parking space 30 to the power supply parking space 40, etc.

The third movement control process described above allows vehicles parked in the charging parking space 50 whose storage ratio SOC of the battery mounted on the vehicle is at the exit battery storage ratio to be moved to the delivery parking space 60. As a result, available space can be created in the charging parking space 50 and the battery mounted on the vehicle can be better charged in the charging parking space 50. It also allows vehicles to be moved quickly to available spaces in the delivery parking space 60. In other words, by making a decision that takes into account the storage ratio SOC of the battery, it is possible to set the storage ratio of the battery in accordance with the user's wishes. In addition, available space may be left in the delivery parking space 60 during normal times, and vehicles parked in the charging parking space 50 that are nearing their scheduled exit date and time may be moved to the delivery parking space 60. In this way, only vehicles that are timed for delivery can be parked in the delivery parking space 60, thereby reducing congestion in the delivery parking space 60. In the third movement management process, the charging parking space 50 corresponds to the “first parking space” and the delivery parking space 60 corresponds to the “second parking space”.

In the first, second, and third movement management processes, the confirmation process (steps S140, S150, S240, S250, S340, S350) is performed, but this confirmation process may be omitted.

In the embodiment, there are the reception parking space 30, the power supply parking space 40, the charging parking space 50, and the delivery parking space 60, and the first movement management process, the second movement management process, and the third movement management process are performed. However, in the case where the charging parking space 50 also serves as the delivery parking space 60, the third movement control process may not be performed. In the case where the power supply parking space 40 also serves as the reception parking space 30, the first movement control process may not be performed. In this case, the vehicle can supply power to the predetermined facility 70 at the same time it starts parking. Furthermore, the reception parking space 30 may also serve as the charging parking space 50 (or the charging parking space 50 may serve as the reception parking space 30). In this case, the vehicle shall travel back and forth between the reception parking space 30 (or the charging parking space 50) and the power supply parking space 40.

In the parking management system 10 of the embodiment, the electric vehicle 120, which uses power from the battery 124 to drive the motor 122 to drive the vehicle, is assumed as a vehicle that can move around each parking space. However, any vehicle that is equipped with a chargeable and dischargeable battery is acceptable. For example, the vehicle may be a hybrid vehicle with an engine, motor, and battery, or a fuel cell vehicle with a fuel cell and battery, or various other configurations.

The parking management system 10 of the embodiment consists of the integrated parking management device 20, the reception parking management device 32, the power supply parking management device 42, the charging parking management device 52, and the delivery parking management device 62, connected by the communication network 12. However, the integrated parking management device 20, the reception parking management device 32, the power supply parking management device 42, the charging parking management device 52, and the delivery parking management device 62 may be configured as a single device.

In the parking management system 10 of the embodiment, an airport is assumed as the predetermined facility 70. However, the predetermined facility 70 may be a large leisure facility with a hotel or other facilities, a shopping center, a railroad station, a port, etc.

In the parking management system of this disclosure, the parking management system may have a movement instruction output section that outputs a movement instruction to move a vehicle for which the movable condition is satisfied to the second parking space when the condition determination section determines that the space condition is satisfied and the movable condition is satisfied. In this case, the movement instruction output section may output the movement instruction to the vehicle when the vehicle movement is by automatic operation, and output the movement instruction to the management terminal when the vehicle movement is by the manager of the predetermined facility. If the vehicle is moved by the automatic operation, the vehicle can be moved to the second parking space by the automatic operation based on the movement instruction. If the vehicle is to be moved by the caretaker of the predetermined facility, it is possible to inform the caretaker of the predetermined facility of the vehicle to be moved to the second parking space.

In the parking management system of this disclosure, the first parking space may be the chargeable parking space where the battery in the parked vehicle can be charged, and the second parking space may be the dischargeable parking space where the battery in the parked vehicle can be discharged. In this case, the movable condition may be a condition in which the energy storage ratio of the battery installed in the vehicle is equal to or greater than the first predetermined energy storage ratio. In this way, the vehicle with the battery storage ratio above the first predetermined storage ratio can be moved to the second parking space to allow the vehicle with the battery storage ratio below the first predetermined storage ratio to be accepted into the first parking space. As a result, it is possible to provide better charging to the battery mounted on the vehicle in the first parking space and it is possible to achieve better discharge from the battery mounted on the vehicle to the predetermined facility in the second parking space. The first predetermined storage ratio can be a value close to full charge, such as 90% or 95%.

In the parking management system of this disclosure, the first parking space may be a chargeable parking space where the battery in the parked vehicle can be discharged; and the second parking space may be a dischargeable parking space where the battery in the parked vehicle can be charged. In this case, the movable condition may be a condition where the energy storage ratio of the battery installed in the vehicle is less than the second predetermined energy storage ratio. In this way, the vehicle with a battery storage ratio of less than the second predetermined storage ratio can be moved to the second parking space to allow the vehicle with a battery storage ratio of more than the second predetermined storage ratio to be accepted into the first parking space. As a result, it is possible to achieve better discharge from the battery mounted on the vehicle in the first parking space to the predetermined facility, and it is possible to provide better charging of the battery mounted on the vehicle in the second parking space. The second predetermined storage ratio can be a relatively low value, such as 20%, 30%, or 40%.

In the parking management system of this disclosure, the first parking space may be a chargeable parking space where the battery in the parked vehicle can be charged; and the second parking space may be a delivery parking space where the parked vehicle is handed over to the user. In this case, the movable condition may be a condition where the storage ratio of the battery installed in the vehicle is the specified storage ratio specified by the user. In this way, the vehicle with the battery energy storage ratio of the designated energy storage ratio can be moved to the second parking space to allow the vehicle with the battery energy storage ratio of the designated energy storage ratio to be accepted into the first parking space. As a result, it is possible to provide better charging of the battery mounted on the vehicle in the first parking space, and it is possible to park the appropriate vehicle in the second parking space. The designated storage ratio may mean the specified storage ratio when the user has clearly specified the storage ratio, or it may mean the storage ratio at the start of parking when the user has not clearly specified the storage ratio. The specified energy storage percentage may mean, when the user's designation is the amount of power to be charged, the ratio of the sum of the specified amount of power and the residual capacity to the total capacity of the battery, and it may also mean, when the user's designation is the amount of money required to charge the battery, the ratio of the sum of the amount of power divided by the amount per unit of power and the residual capacity to the total capacity of the battery.

The following is an explanation of the correspondence between the main elements of the embodiment and the main elements of the disclosure described in the section on means to solve the problem. In the embodiment, in the first movement management process, the reception parking space 30 corresponds to the “first parking space,” the power supply parking space 40 corresponds to the “second parking space,” the reception parking management device 32 corresponds to the “first information management section,” the power supply parking management device 42 corresponds to the “second information management section,” and the integrated parking management device 20 corresponds to the “condition determination section”. In the second movement management process, the power-supply parking space 40 corresponds to the “first parking space,” the charging parking space 50 corresponds to the “second parking space,” the power-supply parking management device 42 corresponds to the “first information management section,” the charging parking management device 52 corresponds to the “second information management section,” and the integrated parking management device 20 corresponds to the “condition determination section”. In the third movement management process, the charging parking space 50 corresponds to the “first parking space,” the delivery parking space 60 corresponds to the “second parking space,” the charging parking management device 52 corresponds to the “first information management section,” the delivery parking management device 62 corresponds to the “second information management section,” and the integrated parking management device 20 corresponds to the “condition determination section”.

The correspondence between the major elements of the embodiment and the major elements of the disclosure described in the means to solve a problem section is an example of how the embodiment can be used to specifically explain the embodiment of the disclosure described in the means to solve a problem section. This does not limit the elements of the disclosure described in the means to solve the problem section. In other words, interpretation of the disclosure described in the means to solve a problem section should be based on the description in that section, and the embodiment is only one specific example of the disclosure described in the means to solve a problem section.

The above is a description of the form for implementing this disclosure using the embodiment. However, the present disclosure is not limited in any way to these embodiments, and can of course be implemented in various forms within the scope that does not depart from the gist of the present disclosure.

### INDUSTRIAL APPLICABILITY

This disclosure can be used in the manufacturing industry for an integrated parking management device or a parking management system.

1. A parking management system for a predetermined facility with multiple parking spaces, including a first parking space and a second parking space;
wherein the parking management system comprising
a first information management section that manages first parking information related to parking in the first parking space and first vehicle information related to vehicles parked in the first parking space;
a second information management section that manages second parking information related to parking in the second parking space and second vehicle information related to vehicles parked in the second parking space;
a condition determination section that determines the existence of a space condition in which a parkable space exists in the second parking space based on the second parking information of the second information management section, and determines the existence of a movable condition where a movable vehicle exists in the second parking space based on the first vehicle information of the first parking management section.

2. The parking management system according to claim 1,
wherein the parking management system comprising a movement instruction output section that outputs a movement instruction to move a vehicle for which the movable condition is satisfied to the second parking space when the condition determination section determines that the space condition is satisfied and the movable condition is satisfied.

3. The parking management system according to claim 2,
wherein the movement instruction output section outputs the movement instruction to the vehicle when the vehicle movement is by automatic operation, and outputs the movement instruction to a management terminal when the vehicle movement is by the manager of the predetermined facility.

4. The parking management system according to claim 1,
wherein the first parking space is a chargeable parking space where the battery installed in the parked vehicle can be charged, and
the second parking space is a dischargeable parking space where the battery installed in the parked vehicle can be discharged.

5. The parking management system according to claim 4,
wherein the movable condition is a condition in which the energy storage ratio of the battery installed in the vehicle is equal to or greater than the first predetermined energy storage ratio.

6. The parking management system according to claim 1,
wherein the first parking space is a chargeable parking space where the battery installed in the parked vehicle can be discharged; and
the second parking space is a dischargeable parking space where the battery installed in the parked vehicle can be charged.

7. The parking management system according to claim 6,
wherein the movable condition is a condition where the energy storage ratio of the battery installed in the vehicle is less than the second predetermined energy storage ratio.

8. The parking management system according to claim 1,
wherein the first parking space is a chargeable parking space where the battery installed in the parked vehicle can be charged; and
the second parking space is a delivery parking space where the parked vehicle is handed over to the user.

9. The parking management system according to claim 8,
wherein the movable condition is a condition where the storage ratio of the battery installed in the vehicle is the storage ratio specified by the user.
